(19) United States
(12) Patent Application Publication
(10) Pub. No.: US 2025/0224649 A1
(43) Pub. Date: Jul. 10, 2025

(54) EXCITONIC MACH ZEHNDER MODULATOR

(71) Applicant: The Regents of the University of California, Oakland, CA (US)

(72) Inventor: Leonid Butov, Encinitas, CA (US)

(21) Appl. No.: 18/853,845

(22) PCT Filed: Apr. 3, 2023
(86) PCT No.: PCT/US2023/065273

§ 371 Date: Oct. 3, 2024

Related U.S. Application Data
(60) Provisional application No. 63/329,148, filed on Apr. 8, 2022.

(51) Int. Cl. G02F 1/21; G02F 1/225

(52) U.S. Cl. CPC G02F 1/212; G02F 1/2257

(57) ABSTRACT

An integrated excitonic Mach Zehnder modulator includes a heterostructure of material to create an exciton or optical input and output and two arms for excitons between the input and the output. An interference control electrode on one of the arms is used to control exciton or optical output. The materials are selected and arranged such that combining excitons at the output is controlled by voltage applied to the interference control electrode such that exciton matter waves are in phase and the interference is constructive when the output signal is on, and when the exciton matter waves are out of phase the interference is destructive and the output signal is off.

### PRIORITY CLAIM AND REFERENCE TO RELATED APPLICATION

The application claims priority under 35 U.S.C. § 119 and all applicable statutes and treaties from prior U.S. provisional application Ser. No. 63/329,148, which was filed Apr. 8, 2022.

### FIELD

Fields of the invention include optoelectronics, electrooptical modulators, optical communication links, and optical transmitters.

### BACKGROUND

Van der Waals (vdW) heterostructures based on transition metal dichalcogenides (TMDs) have been studied for applications such as excitonic integrated circuits. Jiang et al., “Interlayer exciton formation, relaxation, and transport in TMD van der Waals heterostructures,” Light: Science & Applications (2021) 10:72. Conventional heterostructure devices with spatially direct excitons (DXs), aka intralayer excitons, exhibit short exciton lifetimes, e.g., in the range of picoseconds [Korn et al, “Low-temperature photocarrier dynamics in monolayer MoS2”, Appl. Phys. Lett. 99, 102109 (2011).] Spatially indirect excitons (IXs), aka interlayer excitons, composed of electrons and holes confined in separated layers, can have long lifetimes. Such IXs have been used for excitonic transistor devices. See, Jian et al., Interlayer exciton formation, relaxation, and transport in TMD van der Waals heterostructures,” Light: Science & Applications (2021) 10:72; High et al., “Control of exciton fluxes in an excitonic integrated circuit,” Science 321, 229 (2008); Grosso et al., “Excitonic switches operating at around 100 K,” Nature Photonics volume 3, pages 577-580 (2009).

A Mach-Zehnder modulator (MZM) is an optical interferometric structure made from a material having a strong electro-optic effect. An optical input signal is split into two arms. Applying an electric field to one or both arms modifies the phase of one or both optical signals before they are combined and form an interferometric output. Optical MZMs have applications ranging from sensing to simulation to opto-electronic circuits. Within an MZM, photons are used as carriers. Photons have relatively low sensitivity to electric fields.

A challenge for photonics is the realization of energy-efficient signal control at nanoscale. In optical MZMs, the amplitude of optical wave at the output is controlled by applying voltage that introduces a phase shift in the light wave passing through an MZM arm. The phase shift is determined by the change of the refractive index induced by applied voltage. Even for materials with large electro-optic coefficient, such as lithium niobite, the switching requires devices with significant lengths and large applied voltages. An estimate for switching voltage is given by the voltage required to change the phase by π, V_{π}. Even for conventional MZM with a large electro-optic coefficient 30 pm/V, V_{π}˜10 V for L˜3 mm (for characteristic parameters). Such large-sized and high-voltage prior photonic MZM devices have limited application because of those characteristics.

### SUMMARY OF THE INVENTION

A preferred embodiment provides an excitonic Mach Zehnder modulator. The integrated excitonic MZM modulator includes a heterostructure of material to create an exciton or optical input and output and two aims for excitons between the input and the output. An interference control electrode on one of the arms is used to control exciton or optical output. The materials are selected and arranged such that combining excitons at the output is controlled by voltage applied to the interference control electrode such that exciton matter waves are in phase and the interference is constructive when the output signal is on, and when the exciton matter waves are out of phase the interference is destructive and the output signal is off.

### BRIEF DESCRIPTION OF THE DRAWINGS

FIGS. 1A-1C are schematic diagrams of preferred excitonic Mach Zehnder modulator units of the invention; FIG. 1A is an X-Y diagram of a preferred MZM unit of the invention; FIGS. 1B and 1C are Energy-Z diagrams of preferred material layers in respective Type 1 and Type 2 preferred structures for spatially indirect excitons (IXs) that are options for the FIG. 1A MZM unit.

### DETAILED DESCRIPTION OF THE PREFERRED EMBODIMENTS

The invention provides an excitonic Mach-Zehnder modulator (X-MXM), which can modulate either of excitonic or optical signals. In excitonic devices, input(s)/output(s) can be excitonic, optical, or electronic. For the present X-MZM device, an optical signal can be accepted at X-MZM input and an optical signal output produced at X-MZM output. At an X-MZM input, light transforms to excitons. The excitonic signal is controlled in the X-MZM device, or in an excitonic circuit including a number of the present X-MZM, and excitons can transform to light at an output. Alternatively, an input can be excitonic signal and an output can be an excitonic signal which can be transmitted to another excitonic device. Electronic modulation or switching of optical signals is realized using excitons, which are more sensitive to modulation and responsive to very small electric fields as shown by the estimates below indicating that the switching voltages V, are orders of magnitude smaller for X-MZM in comparison to optical MZM.

The present X-MZM devices can also be used to form hybrid circuits including other optical devices. An output from an X-MZM can be transformed to photons before combining with photonic signals from other optical devices.

Preferred X-MZM devices leverage long-range IX transport. Excitons can travel long distances (tens and hundreds of micrometers) through the present X-MZM devices before recombination. X-MZM devices leverage heterostructures composed e.g. of Group III-V materials or transition metal dichalcogenides (TMDs).

Preferred X-MZM devices enable low-energy signal control and linking electronic computation with optical communication. The present X-MZM devices leverage interference of exciton matter waves and offer both sizes and the energy efficiency orders of magnitude smaller than conventional optical MZM technology. X-MZM devices can modulate excitonic or optical signals at nanoscale (total device size in X-Y plane is nanoscale, e.g. ˜300 nm size between input and output, and height/Z direction is nanoscale, with individual layers typically being a fraction of nanometer to tens of nanometers thick in TMD structures and a few to hundreds of nanometers thick in III-V structures). Modulation can be conducted with voltages orders of magnitude smaller than in optical MZM devices. X-MZM computation can be linked with optical communication.

Preferred embodiments of the invention will now be discussed with respect to experiments and drawings. Broader aspects of the invention will be understood by artisans in view of the general knowledge in the art and the description of the experiments that follows.

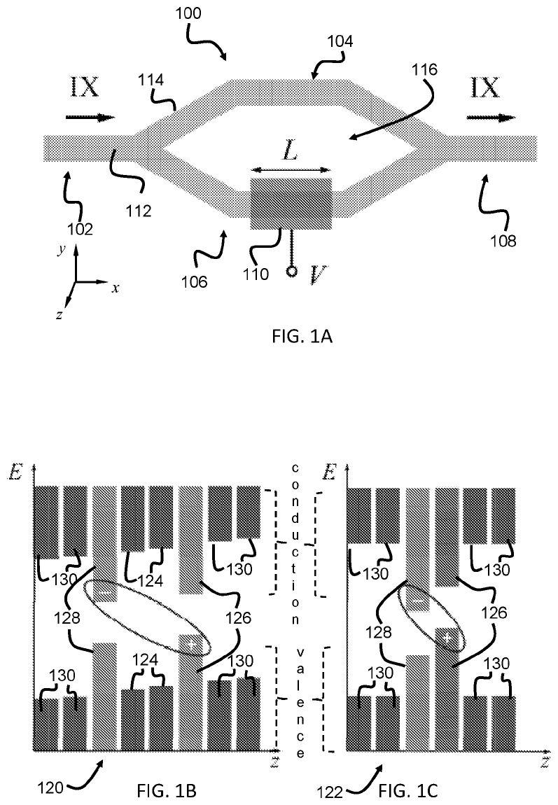

A preferred X-MZM 100 in FIG. 1 is based on interference of exciton matter waves. In the X-MZM 100, an excitonic signal from input 102 is split into two interferometer arms 104 and 106 and an output 108 provides an output signal that is controlled by the phase difference between the exciton matter waves. An interference control electrode 110 is used to control phase in the arm 106, though both arms 106 and 104 could each have an interference control electrode for active control of the phase in both arms. The two anns 104 and 106 can be defined physically or by applied voltage. In the case of guiding via applied voltage, a top shaped electrode 112 permits applied voltage to guide excitons from the input 102, into both arms 104 and 106 and then combine excitons from the both arms at the output 108. The shaped electrode 112 is preferably formed by a graphene layer or by other conducting material. Such voltage application creates an excitonic guide and the guide path is determined by the shape of the top electrode. Alternatively, the excitonic guide can be physically created by shaping a heterostructure 114 in x-y plane, e.g. by etching or via pattened deposition to include an excitonic barrier area 116 that does not support or guide excitons. The excitonic barrier area 116 can be exciton barrier material or an absence of material. The interference control electrode 110 can be separated from the waveguide electrode 112, e.g. by small distance in x-y plane. Different voltages can be applied to arms 104 and 106 via interference control electrodes in each arm to maximize the phase shift for the two arms and, as a result, achieve switching/modulation of the signal at smaller voltage.

The materials and length L of the interference control electrode 110 are selected such that when the exciton matter waves are in phase the interference is constructive and the output signal is on, and when the exciton matter waves are out of phase the interference is destructive and the output signal is off. An example L estimated in [0022] is 300 nm and L can be smaller or larger than this value depending on the application. L determines the X-MZM dimensions. The lengths of arms 104 and 106 beyond electrode 110 should be sufficient to complete the geometry of the X-MZM 100. All x-y dimensions of the X-MZM 100 should be larger than the exciton size (Bohr radius). However, the exciton radius is typically small (for TMD˜1 nm, for GaAs˜10 nm) so this limitation does not compromise the small X-MZM dimensions. In the X-MZM 100, the amplitude of an exciton matter wave at the output 108 is controlled by applying voltage to the interference control electrode 110 that introduces a phase shift in the exciton matter wave passing through the MZM arm 106.

FIGS. 1B and 1C are energy diagrams showing the conduction and valence bands for layers in a heterostructure 120 or 122 of the X-MZM 100. In an example TMD heterostructure, each “bar” in the diagrams represents a monolayer that is a layer with the thickness of one atom, in III-V semiconductor heterostructure each “bar” in the diagram typically represents multiple monolayers. The heterostructure 120 includes zero or more barrier layers 124 between hole confinement 126 and electron confinement 128 semiconductor layers. Spatially indirect excitons (IXs) are composed of electrons and holes in separated layers, with the hole confined in layer 126 and electron confined in layer 128. The hole confinement 126 and electron confinement 128 semiconductor layers can be the same material or different materials. The heterostructure 122 may or may not include a barrier layer 124 and the hole confinement 126 and electron confinement 128 semiconductor layers are different materials. Both heterostructures 120 and 122 preferably include cap layers 130. Preferred cap layers for TMD heterostructures are hBN, preferred cap layers for GaAs heterostructures are AlGaAs followed by GaAs. The ovals indicate excitons. The heterostructures 120 and 122 are formed on a suitable substrate. Suitable substrates include graphite for TMD heterostructures or GaAs for GaAs heterostructures.

The heterostructures 120 and 122 can include TMD or Group III-V semiconductor and barrier materials. Preferred TMD semiconductor materials include MoS₂, MoSe₂, and WSe₂, and hBN is the preferred barrier/cap material. Generally, TMD material that is stable at ambient conditions with a cap layer can be used. Preferred Group III-V semiconductor materials include AlAs and GaAs, a preferred barrier material include AlGaAs, and a preferred cap material include AlGaAs followed by GaAs. The TMD materials are selected such that excitons have sufficiently high binding energies to be stable at ambient conditions. Preferred heterostructures for the X-MZM include MoS₂/hBN heterostructure with electron confinement and hole confinement layers in MoS₂ separated by an hBN barrier. MoS₂ can be replaced by other TMD material such as MoSe₂ or WSe₂. Another preferred structure uses GaAs for electron confinement and hole confinement layers and AlGaAs for a barrier. Another preferred structure is MoSe₂/WSe₂ heterostructure with the electron confinement layer in MoSe₂ and hole confinement layer in WSe₂. Another preferred structure is an AlAs/GaAs heterostructure with the electron confinement layer in AlAs and hole confinement layer in GaAs.

Excitons in heterostructures 120 or 122 have built-in electric dipoles ed (e is electron charge, dis the separation between the electron and hole layers) and their energy is effectively controlled by voltage applied to the device electrodes, such as the interference control electrode 110 and the shaped electrode 112. The recombination rate is also effectively controlled by applied voltage(s). Switching the recombination off allows excitons to travel over long distances reaching and exceeding hundreds of microns. Excitons can therefore travel through the entire X-MZM 100 device. Excitons can transform to photons to provide an optical output at the output 108, or can be transmitted to another X-MZM devices as excitons. An optical readout of the X-MZM 100 can be controlled by voltage applied to output region 108 to increase exciton conversion to photons.

An exciton (X) wave is confined in the heterostructure layers of the structures 120 or 122 and guided in x-y plane by shaped-electrode excitonic guide 112 or physical heterostructure shaped guide 114. The layers 126 and 128 confine excitons composed from holes (+) and electrons (−) in the z direction. Optical guides can also be used to guide photons to the source and out of the drain of X-MZM 100.

The switching of the X-MZM 100 is achieved with both lengths and voltages that are much smaller than for conventional optical MZM. The X-MZM 100 can provide nanoscale devices operating with low switching voltages, with the energy efficiency orders of magnitude smaller than conventional optical MZM technology.

In a conventional optical MZM the amplitude of optical wave at the output is controlled by applying voltage that introduces a phase shift in the light wave passing through the optical MZM arm. The phase shift Δψ˜ΔnkL is determined by the change of the refractive index induced by applied voltage Δn∞rV. Even for materials with large electro-optic coefficient r, such as lithium niobite, the switching requires devices with large lengths L and large applied voltages V. An estimate for switching voltage is given by the voltage required to change the phase by π: V_{π}˜D/(n³rL). Even for MZM with large r=30 pm/V, V_{π}˜10V for L˜3 mm (for typical parameters: wavelength λ=1 μm, separation between the electrodes D=10 μm). The photonic MZM devices thus have large sizes and require high applied voltage.

In contrast, the present IXs in X-MZM 100 include built-in electric dipoles ed, and IX energy is controlled by voltage ΔE∞Vd. The amplitude of an exciton matter wave at the output 108 is controlled by applying voltage at electrode 110 that introduces a phase shift in the exciton matter wave passing through the arm 106. The phase shift Δψ˜ΔknL is determined by the change of wave vector Δk˜dk/dE·ΔE induced by applied voltage, which controls ΔE. When the X-MZM 100 is fabricated in van der Waals transition metal dichalcogenide (TMD) heterostructures composed of MoSe₂/WSe₂ bilayer encapsulated by hBN, ΔE˜Vdeε_{hBN}/(Dε_{TMD}) and

$${V}_{π} = π ℏ {( \frac{2 E}{m} )}^{1 / 2} / ( enL ) .$$

Dε_{TMD}/(dε_{hBN}). The estimate gives V_{π}˜10 meV for L˜300 nm (for typical parameters: d˜1 nm, D˜20 nm, m˜m₀, ε_{hBN}=3.8, ε_{TMD}=7.4) The exciton energy corresponding to the thermal energy at room temperature is E˜25 meV. Switching of the example TMD X-MZM 100 is achieved with small L and V_{π}. For the example TMD X-MZM, V_{π}·L is ˜10⁷ smaller than the conventional photonic MZM. With respect to the electrode length and length of the X-MZM 100, V_{π}∞1/L, therefore a smaller size L of electrode 110 and, in turn, of the entire X-MZM can be used when a higher voltage V_{π} is used for X-MZM switching, or a smaller switching voltage V_{π} can be used when L is larger. L and V_{π} can be optimized for the application

While preferred embodiments have been described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An integrated excitonic Mach-Zehnder modulator (MZM) comprising a heterostructure of material to create an exciton or optical input and output and two arms for excitons between the input and the output, an interference control electrode on one of the arms to control exciton or optical output, wherein the materials are selected and arranged such that combining excitons at the output is controlled by voltage applied to the interference control electrode such that exciton matter waves are in phase and the interference is constructive when the output signal is on, and when the exciton matter waves are out of phase the interference is destructive and the output signal is off.

2. The integrated excitonic MZM of claim 1, wherein the heterostructure comprises a Group III-V heterostructure.

3. The integrated excitonic MZM of claim 1, wherein the heterostructure comprises transition metal dichalcogenide (TMD) heterostructure.

4. The integrated excitonic MZM of claim 1, wherein the heterostructure comprises a hole confinement layer and an electron confinement layer separated by a distance d from each other.

5. The integrated excitonic MZM of claim 4, comprising a barrier layer between the hole confinement layer and the electron confinement layer.

6. The integrated excitonic MZM of claim 1, wherein the heterostructure comprises transition metal dichalcogenide (TMD) heterostructure, the TMD heterostructure comprising a hole confinement layer and an electron confinement layer.

7. The integrated excitonic MZM of claim 6, wherein the hole confinement layer and the electron confinement layer comprise TMD semiconductor layers of the same material separated by a barrier layer of hBN.

8. The integrated excitonic MZM of claim 7, wherein the TMD semiconductor layers are selected from semiconductor TMD such as MoS₂, MoSe₂, WS₂, and WSe₂.

9. The integrated excitonic MZM of claim 6, wherein the hole confinement layer and the electron confinement layer comprise TMD semiconductor layers of different material.

10. The integrated excitonic MZM of claim 9, wherein the TMD semiconductor layers are selected from semiconductor TMD such as MoS₂, MoSe₂, WS₂, and WSe₂.

11. The integrated excitonic MZM of claim 1, wherein the heterostructure comprises a Group III-V heterostructure, the Group III-V heterostructure comprising a hole confinement layer and an electron confinement layer.

12. The integrated excitonic MZM of claim 11, wherein the hole confinement layer and the electron confinement layer comprise semiconductor layers of the same material separated by a barrier layer.

13. The integrated excitonic MZM of claim 7, wherein the semiconductor layers are selected from AlGaAs and GaAs.

14. The integrated excitonic MZM of claim 11, wherein the hole confinement layer and the electron confinement layer comprise semiconductor layers of different material.

15. The integrated excitonic MZM of claim 9, wherein the semiconductor layers are selected from AlAs and GaAs.

16. The integrated excitonic MZM of claim 1, wherein the two arms comprise a physically shaped heterostructure.

17. The integrated excitonic MZM of claim 16, wherein the two arms are separated by an excitonic barrier area.

18. The integrated excitonic MZM of claim 17, wherein the excitonic barrier area comprises material or open space.

19. The integrated MZM modulator of claim 1, wherein the two arms comprise a shaped electrode that guides excitons upon application of voltage.
